(19) United States
(12) Patent Application Publication
(10) Pub. No.: US 2025/0172038 A1
(43) Pub. Date: May 29, 2025

(54) Architectural Panel Mounting Systems and Methods

(71) Applicant: Cambridge International, Inc., Cambridge, MD (US)

(72) Inventors: Hendrik A. Phillips, Seaford, DE (US); Keith M. Rose, Delmar, DE (US); Matthew C. O'Connell, Cambridge, MD (US)

(21) Appl. No.: 18/954,106

(22) Filed: Nov. 20, 2024

Related U.S. Application Data
(60) Provisional application No. 63/602,873, filed on Nov. 27, 2023.

(51) Int. Cl. E06B 9/01

(52) U.S. Cl. CPC E06B 9/01; E06B 2009/015

(57) ABSTRACT

Architectural panel mounting systems and methods are provided, including a panel, a first rail coupled to the panel, a second rail coupled to the panel, a first bracket, and a second bracket. The first rail is coupled to the first bracket and configured to slide laterally relative to the first bracket. The second rail is coupled to the second bracket and configured to slide laterally relative to the second bracket.

### CROSS-REFERENCE TO RELATED APPLICATIONS

This application claims priority under 35 U.S.C. § 119 to U.S. Provisional Patent Application No. 63/602,873 filed on Nov. 27, 2023, the entire contents of which is incorporated herein by reference.

### BACKGROUND

The present invention is directed to architectural panel mounting systems and methods and, more specifically, architectural panel tension mounting systems and methods comprised of elongated rails that couple the architectural panel to mounting brackets.

Architectural panels have a wide range of exterior and interior applications, such as façades, canopies, ceilings, and walls. For example, architectural panels can add an aesthetic look to a building façade while also providing additional benefits such as security, shade, and ventilation. Large panels, such as those spanning the heights of a building can be used, for example, on parking garages in order to improve the appearance thereof. These large panels are typically mesh panels manufactured from a flexible mesh of woven metal and incorporate a tensioning system to apply pre-tension to the mesh panel. The tensioning system is used to keep the mesh taught and to control the movement and appearance of the panel, such as when subject to large wind loads or ambient temperature variations.

Current architectural panel tensioning systems use formed stainless steel, which must be made-to-order according to the specific application. For example, different mesh types and panel widths require different bindings for mounting the mesh panel to the mounting brackets, and such lack of commonality between components results in shorter production runs and a larger required inventory of components. Additionally, such current systems include pre-determined mounting locations between the mesh and associated mounting brackets. As a result, aligning the mesh and mounting brackets at these locations when hanging large, heavy mesh panels on buildings in the field can be difficult as there is little to no adjustability when working around field conditions.

Accordingly, there exists a need for improved tension mounting systems and methods for architectural panel applications.

### SUMMARY OF THE DISCLOSURE

Some embodiments provide an architectural panel mounting system configured to be coupled to a structural support via a first bracket, a second bracket, and a third bracket. The architectural panel mounting system includes a first rail, a first set of mounting fasteners, a second rail, a second set of mounting fasteners, a third rail, a third set of mounting fasteners, and a mesh panel. The first rail includes a first panel receiving track and a first fastener receiving track, wherein the first set of mounting fasteners are configured to be received into the first fastener receiving track and are configured to be coupled to the first bracket. Further, the first set of mounting fasteners are slidable within the first fastener receiving track. The second rail includes a second panel receiving track and a second fastener receiving track, wherein the second set of mounting fasteners are configured to be received into the second fastener receiving track and are configured to be coupled to the second bracket. Further, the second set of mounting fasteners are slidable within the second fastener receiving track. The third rail includes a third fastener receiving track, wherein the third set of mounting fasteners are configured to be received into the third fastener receiving track and are configured to be coupled to the third bracket. Additionally, the mesh panel is configured to be received into the first panel receiving track and the second panel receiving track.

In some embodiments, the first rail, the second rail, and the third rail are extruded rails. Furthermore, in some embodiments, the first rail, the second rail, and the third rail are aluminum extrusions.

In some embodiments, the first set of mounting fasteners include carriage bolts, the second set of mounting fasteners include spring-loaded carriage bolts, and/or the third set of mounting fasteners include links that are configured to be received into the third rail. In some embodiments, the links are configured to be rotatable relative to the third bracket when coupled to the third bracket.

In some embodiments, the first rail comprises a central portion separating the first panel receiving track and the first fastener receiving track. Also, in some embodiments, the first panel receiving track and the first fastener receiving track each extend from a first end of the first rail to a second end of the second rail. Furthermore, in some embodiments, the mesh panel is coupled to a first panel end plate along a first end thereof, and the first panel end plate is configured to be received into the first panel receiving track.

Some embodiments provide an architectural panel mounting system including a panel, a first rail coupled to the panel, a second rail coupled to the panel, a first bracket, and a second bracket. The first rail is coupled to the first bracket and configured to be slidable laterally relative to the first bracket. The second rail is coupled to the second bracket and configured to be slidable laterally relative to the second bracket.

In some embodiments, the second rail is coupled to the second bracket using spring-loaded mounting fasteners to hold the mesh panel in tension. In some embodiments, the architectural panel mounting system further includes a third rail coupled to the panel and a third bracket. The third rail is coupled to the third bracket and configured to be slidable laterally relative to the third bracket.

In some embodiments, the panel is configured to be slidable into a first track of the first rail to couple the first rail to the panel. Further, in some embodiments, the mesh panel is coupled to a first panel end plate, and the first panel end plate is configured to be slidable into the first track. Additionally, in some embodiments, the first rail is coupled to the first bracket via mounting fasteners, and the mounting fasteners extend through mounting bracket holes of the first bracket.

Some embodiments provide a method of installing an architectural panel to a structural support. The method includes mounting an upper bracket and a lower bracket to the structural support and inserting an architectural panel into a track of an upper rail. The method also includes coupling the upper rail to the upper bracket by inserting upper rail mounting fasteners into a track of the upper rail and fastening the upper rail mounting fasteners to the upper bracket, and coupling a lower rail to the lower bracket by inserting lower rail mounting fasteners into a track of the lower rail and fastening the lower rail mounting fasteners to the lower bracket. The upper rail mounting fasteners are slidable relative to the track of the upper rail and the lower rail mounting fasteners are slidable relative to the track of the lower rail. The method further includes sliding the architectural panel into a track of the lower rail.

In some embodiments, method further includes mounting a middle bracket to the structural support between the upper bracket and the lower bracket, coupling a middle rail to the middle bracket via links that slide into a track of the middle rail, and coupling the architectural panel to the middle rail. In some embodiments, the architectural panel is slidable relative to the track of the upper rail and the track of the lower rail. Additionally, in some embodiments, inserting the architectural panel into the track of the upper rail includes coupling the architectural panel to a panel end plate and inserting the panel end plate into the track of the upper rail.

The foregoing and other aspects and advantages of the present disclosure will appear from the following description. In the description, reference is made to the accompanying drawings that form a part hereof, and in which there is shown by way of illustration one or more exemplary versions. These versions do not necessarily represent the full scope of the disclosure.

### BRIEF DESCRIPTION OF THE DRAWINGS

The following drawings are provided to help illustrate various features of non-limiting examples of the disclosure, and are not intended to limit the scope of the disclosure or exclude alternative implementations.

FIG. 1 illustrates an isometric view of a set of example brackets for use with an architectural panel tension mounting system.

FIG. 2A illustrates an isometric view of a conventional architectural mesh panel tension mounting system.

FIG. 2B illustrates a partial isometric view of the architectural mesh panel tension mounting system of FIG. 2A, taken from section B of FIG. 2A.

FIG. 2C illustrates a partial isometric view of the architectural mesh panel tension mounting system of FIG. 2A, taken from section C of FIG. 2A.

FIG. 2D illustrates a partial isometric view of the architectural mesh panel tension mounting system of FIG. 2A, taken from section D of FIG. 2A.

FIG. 3A illustrates an isometric view of an example architectural mesh panel tension mounting system according to some embodiments.

FIG. 3B illustrates a partial isometric view of the architectural mesh panel tension mounting system of FIG. 3A, taken from section B of FIG. 3A.

FIG. 3C illustrates a partial isometric view of the architectural mesh panel tension mounting system of FIG. 3A, taken from section C of FIG. 3A.

FIG. 3D illustrates a partial isometric view of the architectural mesh panel tension mounting system of FIG. 3A, taken from section D of FIG. 3A.

FIG. 4 illustrates a side view of the architectural mesh panel tension mounting system of FIG. 3A.

FIG. 5 illustrates a side view of an upper bracket, an upper rail, and an example mesh panel of the architectural mesh tension mounting system of FIG. 3A.

FIG. 6 illustrates an isometric view of an example upper rail of an architectural panel tension mounting system according to some embodiments.

FIG. 7 illustrates a partial isometric view of an example mesh panel and an example panel end plate according to some embodiments.

FIG. 8 illustrates a side view of a lower bracket, a lower rail, and a mesh panel of the architectural mesh panel tension mounting system of FIG. 3A.

FIG. 9 illustrates an isometric view of an example washer of an architectural mesh panel tension mounting system according to some embodiments.

FIG. 10 illustrates an isometric view of another example washer of an architectural mesh panel tension mounting system according to some embodiments.

FIG. 11 illustrates a side view of a middle bracket, a middle rail, and a mesh panel of the architectural mesh panel tension mounting system of FIG. 3A.

FIG. 12 illustrates an isometric view of an example middle rail of an architectural panel tension mounting system according to some embodiments.

FIG. 13 illustrates an isometric view of an example link of an architectural panel tension mounting system according to some embodiments.

FIG. 14 illustrates isometric views of an example middle rail and an example link of an architectural panel tension mounting system according to some embodiments.

FIG. 15 illustrates isometric views of another example middle rail and an example link of an architectural panel tension mounting system according to some embodiments.

FIG. 16 illustrates a side view of another architectural mesh panel tension mounting system according to some embodiments.

FIG. 17 illustrates an isometric view of an example upper rail of an architectural panel tension mounting system according to some embodiments.

FIG. 18 illustrates an isometric view of an example upper rail and mounting fasteners of an architectural panel tension mounting system according to some embodiments.

FIG. 19 illustrates an isometric view of another example upper rail of an architectural panel tension mounting system according to some embodiments.

FIG. 20 illustrates an isometric view of the example upper rail of FIG. 19 including an upper panel end plate inserted therein.

FIG. 21 illustrates a flow chart of a method of installing an architectural panel tension mounting system according to some embodiments.

### DETAILED DESCRIPTION

Some embodiments provide an architectural mesh panel tension mounting system comprising extruded aluminum rails coupled to the top, bottom, and/or middle of mesh panels. Mounting fasteners, such as carriage bolts, engage an upper rail anywhere along its length to couple the upper rail to an upper mounting bracket. Similarly, mounting fasteners, such as spring-loaded carriage bolts, can engage a lower rail anywhere along its length to couple the lower rail to a lower mounting bracket, and links can engage a middle rail anywhere along its length to couple the middle rail to one or more middle mounting brackets. The mounting brackets are further coupled to a structural support.

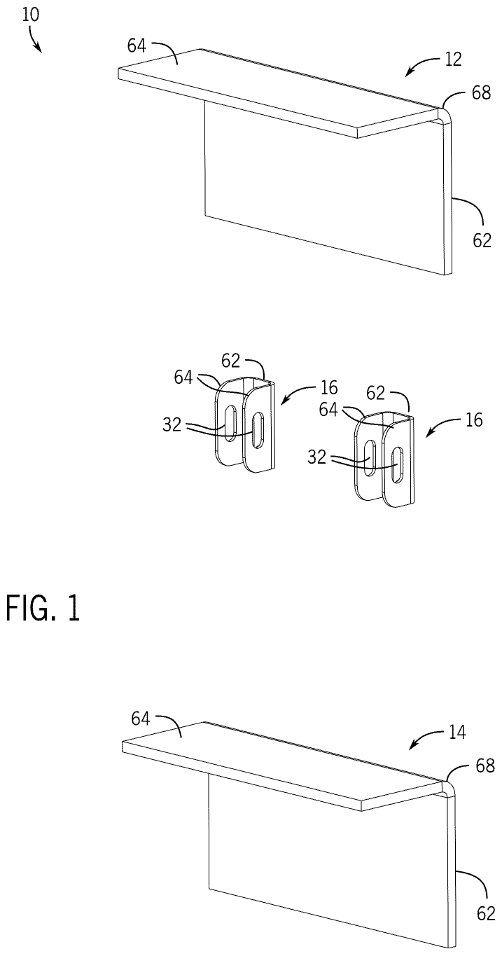

Referring now to the figures, generally, an architectural mesh panel tension mounting system includes a set of mounting brackets 10, like those shown in FIG. 1, coupled to a structural support (e.g., an exterior or interior wall of a building), and a system that couples an architectural panel (e.g., a mesh panel) in tension to the set of mounting brackets 10. The set of mounting brackets 10 can include a first or upper bracket 12, a second or lower bracket 14, and/or one or more third or middle brackets 16 positioned between the upper and lower brackets 12, 14. The set of mounting brackets 10 may be, for example, wall mounting brackets, ceiling mounting brackets, stand-alone structural frame mounting brackets, or other types of brackets that are coupled to or part of a structural support for the architectural mesh.

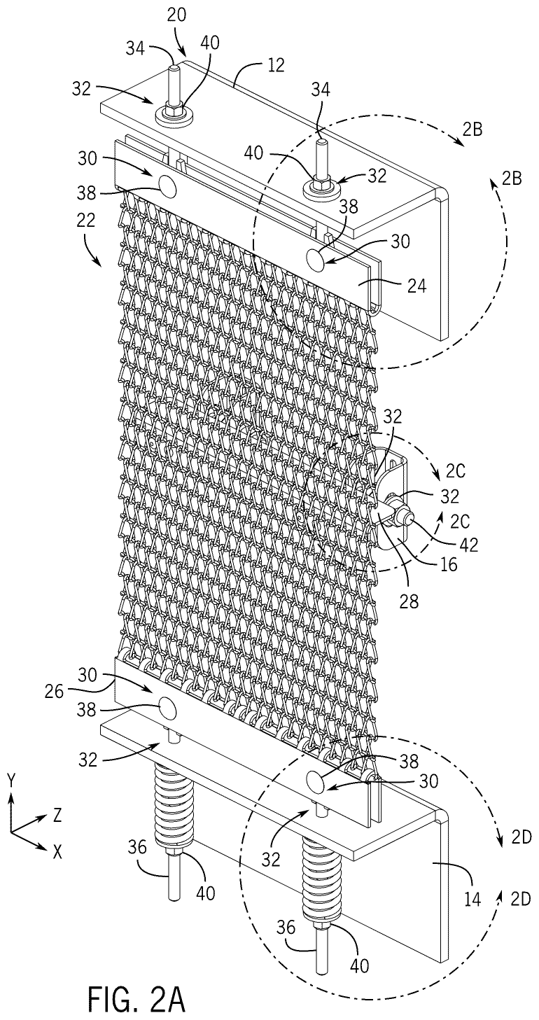

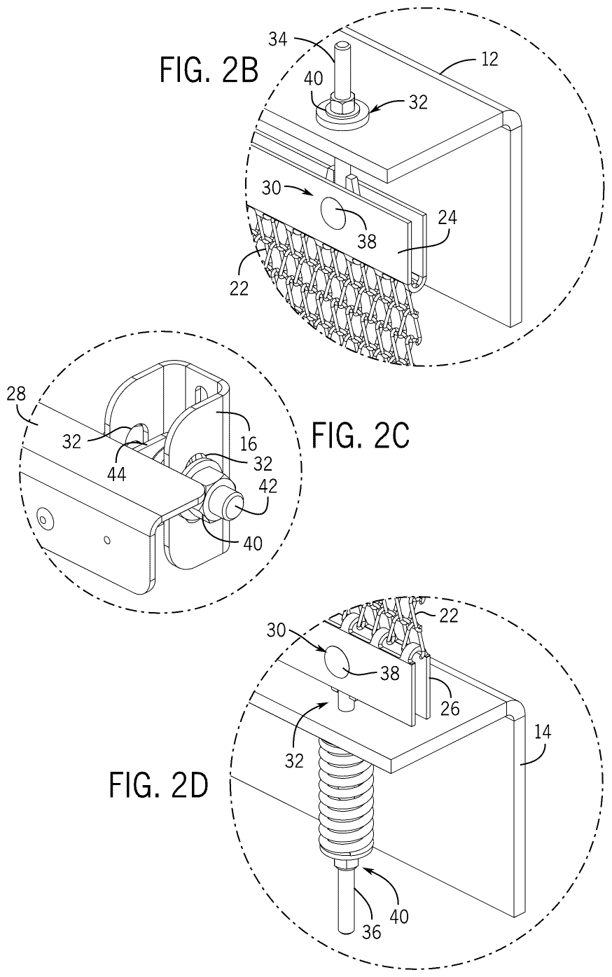

FIGS. 2A-2D illustrate the set of mounting brackets 10 as part of a conventional architectural mesh panel mounting system 20 for mounting an architectural mesh panel 22. The system 20 includes a first or upper binding 24, as shown in FIGS. 2A and 2B, a second or lower binding 26, as shown in FIGS. 2A and 2D, and a middle angle 28, as shown in FIGS. 2A and 2C. At least the bindings 24, 26 are stainless steel and customized to the specific mesh size and panel widths. More specifically, at least the bindings 24, 26 are often laser-cut and formed to specifically engage with the mesh panel 22. Furthermore, at least the bindings 24, 26 include preset binding mounting holes 30, and the upper and lower brackets 12, 14 include pre-set mounting bracket holes 32 that align with the binding mounting holes 30. Eyebolts (e.g., upper eyebolts 34 and lower spring-loaded eyebolts 36) are coupled to the bindings 24, 26 via fasteners 38 that extend through the binding mounting holes 30 and the eyebolts 34, 36. The eyebolts 34, 36 further extend through the mounting bracket holes 32 and are coupled to the brackets 12, 14 via fasteners 40. Additionally, as shown in FIG. 2C, the middle angle 28 is coupled to the middle bracket 16 through a bolt 42 that extends through the mounting holes 32 and a coupling 44 that is further attached to the middle angle 28, and fasteners 40 that couple the bolt 42 to the middle bracket 16.

As shown in FIG. 2A, the binding mounting holes 30 and the mounting bracket holes 32 must be precisely aligned in order to couple the panel 22 to the upper and lower brackets 12, 14. Such alignment can be difficult, for example, when hanging large, heavy mesh panels 22, as there is very limited, if any, side-to-side adjustability between the panels 22 and the brackets 12, 14 (e.g., along the x-axis shown in FIG. 2A). Furthermore, if unforeseen field conditions hinder bracket mounting in a planned location, at least the panel 22 and the bindings 24, 26 need to be adjusted to align with the brackets 12, 14. As a result, the panel 22 may not align properly with adjacent panels 22, potentially hindering the function and/or aesthetics of the architectural mesh. Field conditions may also completely prevent the panel 22 from being installed even with adjustments, and instead require new components to be fabricated and shipped out. Additionally, as different bindings 24, 26 are generally required for panels 22 having different mesh types and sizes, the lack of commonality between components results in custom, made-to-order material requirements, longer lead times, shorter production runs, and/or a larger required inventory.

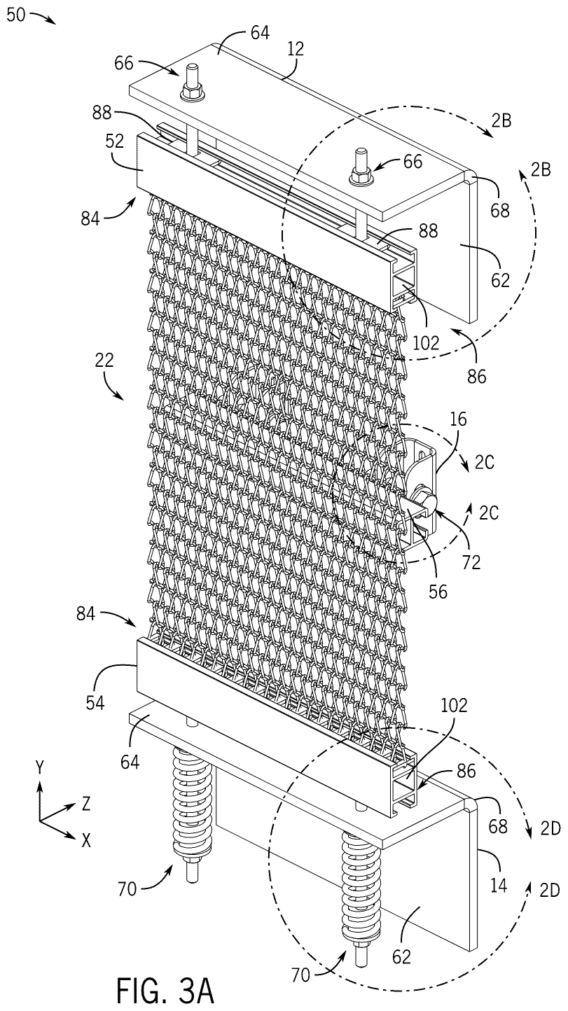

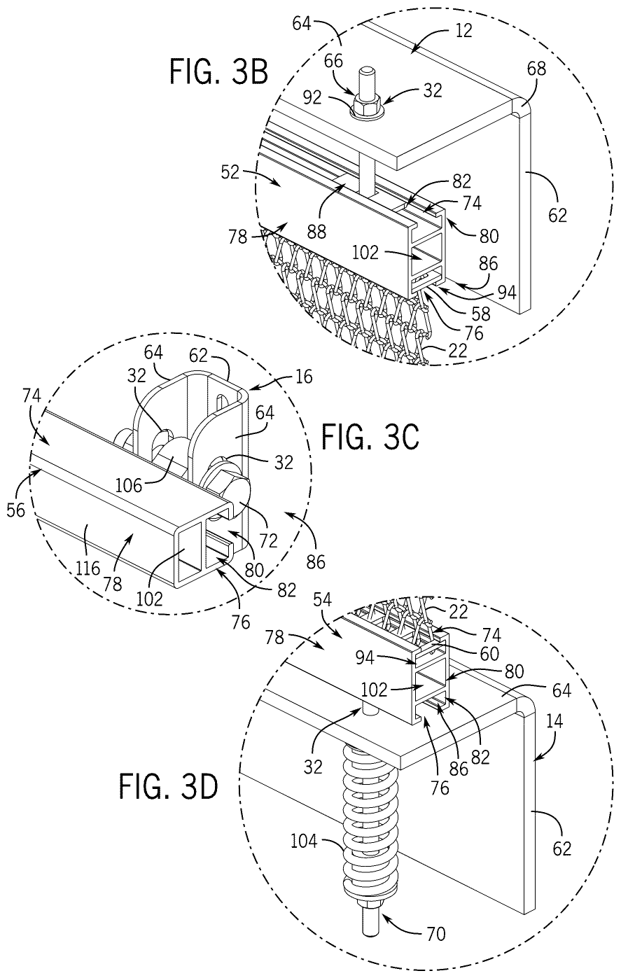

The above drawbacks can be alleviated by an architectural panel tension mounting system 50 according to some embodiments, as shown in FIGS. 3A-11. The system 50 of FIGS. 3A-11 can include a set of brackets and a coupling system including a set of rails, mounting fasteners, and panel end plates. The set of brackets can be the same as or similar to the set of brackets 10 described above with respect to FIG. 1, including an upper bracket 12, a lower bracket 14, and one or more middle brackets 16. Furthermore, the set of rails can include an upper rail 52, a lower rail 54, and a middle rail 56 corresponding to the upper bracket 12, the lower bracket 14, and the middle brackets 16, respectively, and the panel end plates can include an upper panel end plate 58 and a lower panel end plate 60 corresponding to the upper rail 52 and the lower rail 54, respectively. It should be noted that, though numbered differently, in some embodiments, the upper and lower rails 52, 54, the upper and lower brackets 12, 14, and/or the panel end plates 58, 60 may be identical.

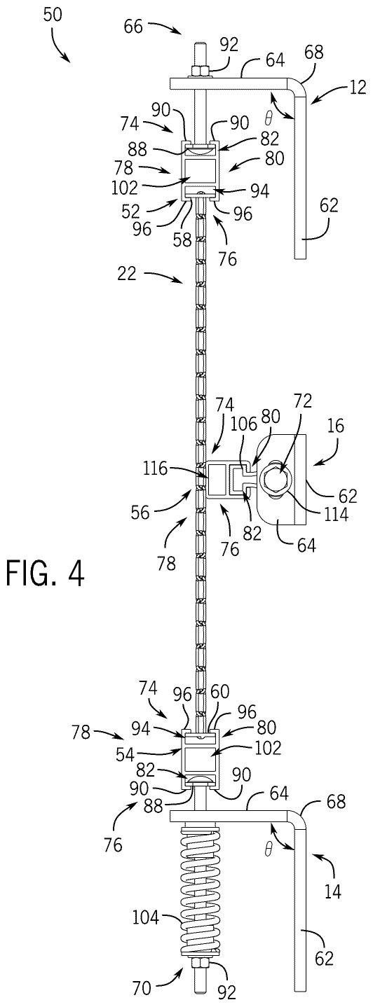

With further reference to the set of brackets 10, in some embodiments, as shown in FIGS. 3A-3D and 4, each set of brackets 10 (e.g., an upper bracket 12, a lower bracket 14, and two middle brackets 16; one of the middle brackets 16 is obscured in FIG. 3A behind the example mesh panel 22) corresponds to a single mesh panel 22. However, in other embodiments, the set of brackets 10 can include different numbers of upper, lower, and middle brackets corresponding to a single panel 22, or multiple panels 22 can correspond to a single set of brackets 10. For example, the total number of middle brackets 16 can vary based on a width and/or a height of the panel 22, such that the middle brackets 16 are spaced along the width and/or the height.

In some embodiments, as shown in FIGS. 1, 3B, and 4, the upper bracket 12 can include a mounting portion 62 and a bracket portion 64. The mounting portion 62 can be coupled to a structural support, such as a wall, a ceiling, a stand-alone structure, etc., and the bracket portion 64 can include mounting bracket holes 32 that receive mounting fasteners 66, as shown in FIGS. 3B and 4. In some embodiments, the upper bracket 12 can be a single, unitary piece with a transition 68 between mounting portion 62 and the bracket portion 64. In some embodiments, the transition can be a 90-degree transition, such that the mounting portion 62 is positioned relative to the bracket portion 64 at an angle θ of about 90 degrees, as shown in FIG. 4. However, the angle θ may be other than 90 degrees in some embodiments, such as an acute angle, an obtuse angle, or any angle up to and including 360 degrees.

Additionally, in some embodiments, the lower bracket 14 can be substantially identical to the upper bracket 12. That is, the lower bracket 14 can include a mounting portion 62 and a bracket portion 64. The mounting portion 62 can be coupled to a structural support, such as a wall, a ceiling, a stand-alone structure, etc., and the bracket portion 64 can include mounting bracket holes 32 that receive mounting fasteners 70, as shown in FIGS. 3D and 4. In some embodiments, the lower bracket 14 can be a single, unitary piece with a transition 68 between mounting portion 62 and the bracket portion 64. In some embodiments, the transition can be a 90-degree transition, such that the mounting portion 62 is positioned relative to the bracket portion 64 at an angle θ of about 90 degrees. However, the angle θ may be other than 90 degrees in some embodiments.

Furthermore, in some embodiments, the lower bracket 14 may not be identical to the upper bracket 12. For example, in some embodiments, the angle θ of the transition 68 of the upper bracket 12 may be different than the angle θ of the transition of the lower bracket 14 in order to properly mount each bracket 12, 14 to the structure on which the panel 22 is to be secured. As another example, while the upper and lower brackets 12, 14 are illustrated in FIGS. 1, 3A, and 4 as including the bracket portion 64 positioned above the mounting portion 62 (e.g., relative to the Y-axis shown in FIG. 3A), in some embodiments, the upper bracket 12 and/or the lower bracket 14 can include the bracket portion 64 positioned below the mounting portion 62.

Referring to FIGS. 1, 3A, 3C, and 4, in some embodiments, each of the middle brackets 16 can be U-shaped brackets including two bracket portions 64 with a mounting portion 62 therebetween. The mounting portion 62 can be coupled to a structural support, such as a wall, a ceiling, a stand-alone structure, etc., and the bracket portions 64 can include mounting bracket holes 32 that receive mounting fasteners 72. As noted above, in some embodiments, as shown in FIGS. 1, 3A, and 4, each set of brackets 10 can include two middle brackets 16. However, as noted above, in other embodiments, each set of brackets 10 can include a single middle bracket 16 or more than two middle brackets 16. For example, middle brackets 16 can be substantially evenly spaced along a width of the panel 22 and/or can be substantially evenly spaced along a height of the panel 22. Furthermore, in some embodiments, depending on the width and/or height of the panel 22, a set of brackets 10 may include zero middle brackets 16, with only upper and lower brackets 12, 14.

As shown in FIGS. 3A-3D and 4, the upper, lower, and middle brackets 12-16 can be coupled to upper, lower, and middle rails 52-56, respectively. With reference now to the rails 52-56, in some embodiments, each rail 52-56 can be formed from extruded aluminum. Furthermore, each rail 52-56 can include a fastener receiving portion and a panel receiving portion. For example, each rail can include a fastener receiving portion on a first side thereof, and a panel receiving portion on a second side thereof, opposite from the first side. As further described below, the fastener receiving portions and/or the panel receiving portions can include tracks that allow for side-to-side variability between the brackets 12-16 and the mesh panel 22 during installation.

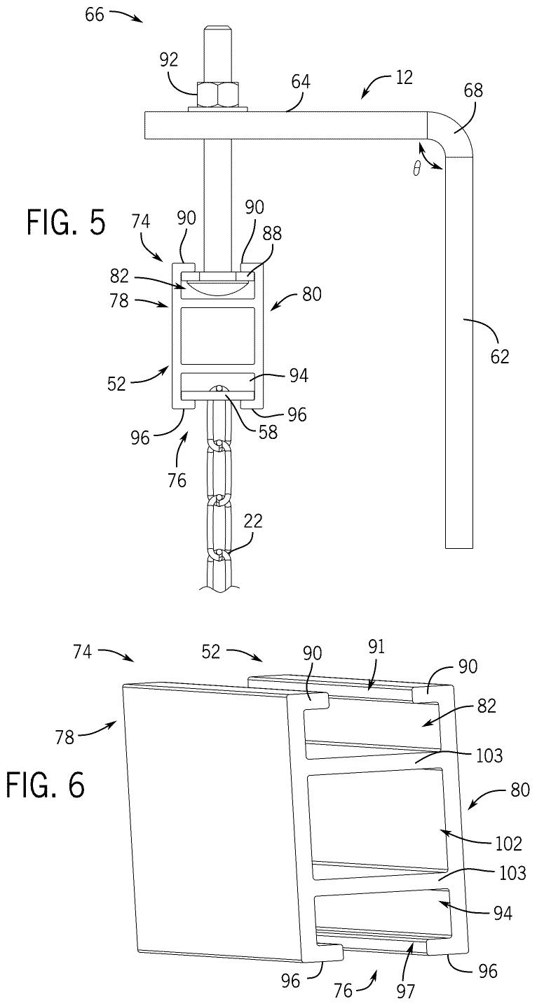

More specifically, FIGS. 5 and 6 illustrate the upper rail 52 according to some embodiments. As shown in FIGS. 5 and 6, the upper rail 52 can include a first side 74, a second side 76 opposite the first side 74, a third side 78, and a fourth side 80. The first side 74 may be an upper side, the second side 76 may be a lower side, the third side 78 may be a front side, and the fourth side 80 may be a rear side. The first side 74 can include a fastener receiving portion, which may be a track 82 that extends from a first end 84 to a second end 86 of the upper rail 52. One or more washers 88 (e.g., rectangular washers) can be slid from the first end 84 or the second end 86 of the upper rail 52 into the track 82 and freely slide laterally through the track 82 (e.g., along a direction parallel to a width of the panel 22, or along an X-axis shown in FIG. 3A). Furthermore, the track 82 can be completely closed relative to the second, third, and fourth sides 76, 78, 80 of the upper rail 52, and partially open relative to the first side 74 of the upper rail 52. That is, along the first side 74, the track 82 can include shoulder portions 90 that prevent the washer 88 from sliding out of the track 82 in a direction parallel to a length of the panel 22 (e.g., along a Y-axis as shown in FIG. 3A). In some embodiments, washers 88 can be substantially flat, rectangular washers 88, as shown in FIG. 9, rectangular, U-shaped washers 88, as shown in FIG. 10, or take on other shapes (e.g., formfactors configured to functionally engage with the respective rail).

Additionally, in some embodiments, each washer 88 can be inserted into the track 82 anywhere along its length, e.g., as opposed to being slid into the first end 84 or the second end 86. More specifically, as shown in FIG. 6, the first side 74 of the upper rail 52 can define an open portion 91 between the shoulder portions 90. A washer 88 can be inserted through the open portion 91 at an angle so that a first side of the washer 88 sits below one of the shoulder portions 90, then the washer 88 and/or the rail 52 pressed, snapped, or flexed until the other side of the washer 88 enters the track 82 below the other shoulder portion 90. As another example, a washer 88 can be dimensioned so that it can be inserted through the open portion 91 into the track 82 in a first orientation, then rotated (e.g., about ninety degrees) to a second orientation such that portions of the washer 88 are directly beneath the shoulder portions 90 to prevent the washer 88 from pulling out of the track 82. Regardless of how the washer 88 is inserted into the track 82, the washer 88 may freely slide along the track 82 once inserted.

As shown in FIGS. 3A, 3B, and 4, a mounting fastener 66, such as a carriage bolt, can extend through the washer 88, extend through a mounting bracket hole 32 in the upper bracket 12, and be secured to the upper bracket 12 via fasteners 92, such as a nut and one or more washers. When the upper rail 52 is engaged with the washer 88, for example, when the washer 88 is inserted along the track 82, the upper rail 52 hangs on the washer 88 as the shoulder portions 90 rest along top sides of the washers 88. Thus, the washer 88 and carriage bolt 66 combination fastens/couples the upper rail 52 to the upper bracket 12. As a result, in some embodiments, the washer 88 and carriage bolt 66 combination can be collectively referred to as a mounting fastener for the upper rail 52.

Furthermore, because the washers 88 can slide anywhere along a length of the track 82 between the first end 84 and the second end 86 of the upper rail 52, there is no singular, preset mounting alignment between the upper bracket 12 and the upper rail 52, allowing for lateral or side-to-side flexibility when mounting the upper bracket 12 to the upper rail 52 in the field. That is, if the upper bracket 12 needs to be shifted over for proper mounting to a structural support, the upper rail 52 may not need to be shifted over as there are no mounting holes on the upper rail 52 that need to precisely align with the mounting bracket holes 32. This makes installation easier as precise alignment is no longer necessary compared to conventional systems and also allows for better aesthetics as preplanned panel placement can generally be maintained regardless of unforeseen bracket mounting impediments in the field.

The present mounting design also allows for any number of mounting fasteners 66 to be used. For example, while two carriage bolts 66 are shown in FIG. 3A, a single bolt 66 or more than two bolts 66 may be used in some applications. While additional mounting bracket holes 32 would need to be drilled/formed/laser cut in the upper bracket 12 to accommodate more bolts 66, no further accommodations need to be made to the upper rail 52, as additional washers 88 need only be inserted into the track 82. Furthermore, as shown best in FIG. 3B, because the washers 88 are slid along a length of the track 82 between the first end 84 and the second end 86 of the upper rail 52 to secure the upper rail 52 to the upper bracket 12, no fasteners are visible along the third side 78 of the upper rail 52. Having a smooth third or front side 78 can be more aesthetically acceptable in some applications.

Referring still to FIGS. 5 and 6, the second side 76 of the upper rail 52 can include a panel receiving portion, which may be a track 94 that extends from the first end 84 to the second end 86 of the upper rail 52. As a result, a panel end plate 58 can be slid into the first end 84 or the second end 86 of the upper rail 52 into the track 94 and freely slide laterally through the track 94 (e.g., along the X-axis shown in FIG. 3A). Furthermore, the track 94 can be completely closed relative to first, third, and fourth sides 74, 78, 80 of the upper rail 52, and partially open along the second side 76. That is, along the second side 76, the track 94 can include shoulder portions 96 that prevent the panel end plate 58 from sliding out of the track 94 in a direction parallel to a length of the panel 22 (e.g., along a Y-axis as shown in FIG. 3A).

Additionally, in some embodiments, the panel end plate 58 can be inserted into the track 94 anywhere along its length, e.g., as opposed to being slid into the first end 84 or the second end 86. More specifically, as shown in FIGS. 4-6 and 8, the second side 76 of the upper rail 52 can define an open portion 97 between the shoulder portions 96. The panel end plate 58 can be inserted through the open portion 97 at an angle so that a first side of the panel end plate 58 sits below one of the shoulder portions 96, then the panel end plate 58 and/or the rail 52 pressed, snapped, or flexed until the other side of the panel end plate 58 enters the track 94 below the other shoulder portion 96. Regardless of how the panel end plate 58 is inserted into the track 94, the panel end plate 58 may freely slide along the track 94 once inserted.

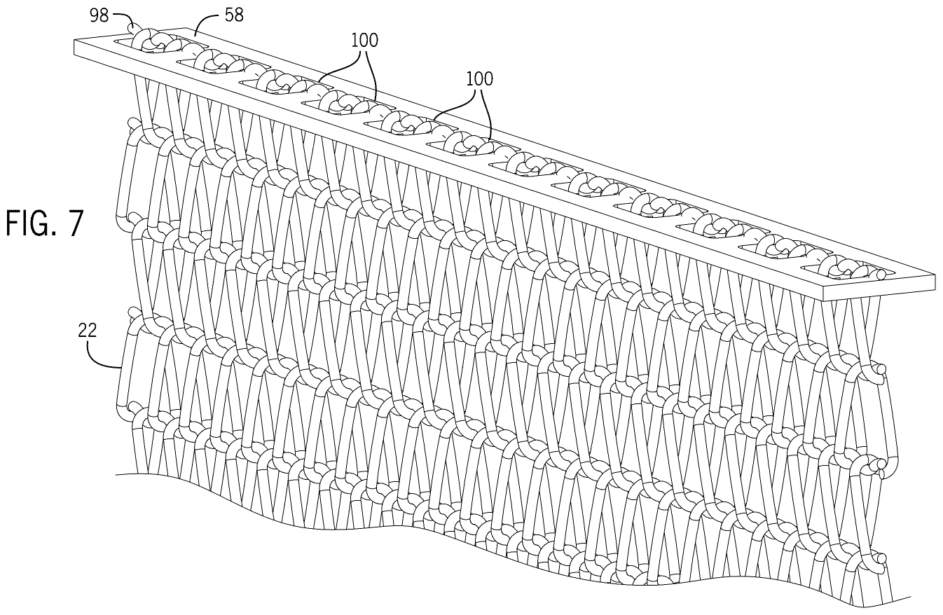

As shown in FIG. 7, the panel end plate 58 can be coupled to the mesh panel 22 via a panel rod 98. That is, the panel end plate 58 can include a plurality of openings 100. The panel 22 can engage the panel end plate 58 so that upper mesh of the panel 22 at least partially extends through the plurality of openings 100, and the panel rod 98 can be inserted or weaved through the upper mesh to prevent the upper mesh from sliding out of the plurality of openings 100. In some embodiments, the panel rod 98 can be wavy or have an S-shape, as shown in FIG. 7. In other embodiments, however, the panel rod 98 can be straight or take on other shapes. Additionally, in some embodiments, the spacing and/or size of the plurality of openings 100 can be customized to the specifications of the mesh panel 22. However, in other embodiments, the spacing and/or size of the plurality of openings 100 can be standardized to fit multiple mesh specifications or sizes. Furthermore, in some embodiments, the panel end plate 58 can be stainless steel, such as powder-coated stainless steel, aluminum, or another suitable material. The panel end plate 58 can be cut to fit the width of the mesh panel 22. However, as the panel end plates 58 are substantially flat plates, the panel end plates 58 need not be formed like prior bindings of conventional mounting systems.

Referring back to FIGS. 5 and 6, when the upper rail 52 is engaged with the panel end plate 58, for example, when the panel end plate 58 is inserted along the track 94, the panel end plate 58 hangs on the upper rail 52 as the panel end plate 58 rests along top sides of the shoulder portions 96. Thus, panel end plate 58 fastens the panel 22 to the upper rail 52. Furthermore, because the panel end plate 58, rather than the panel 22 itself, is coupled to the upper rail 52, a common upper rail 52 can be used for any type of panel (e.g., mesh panel 22). Such standardization can allow for fewer components to be in inventory at one time.

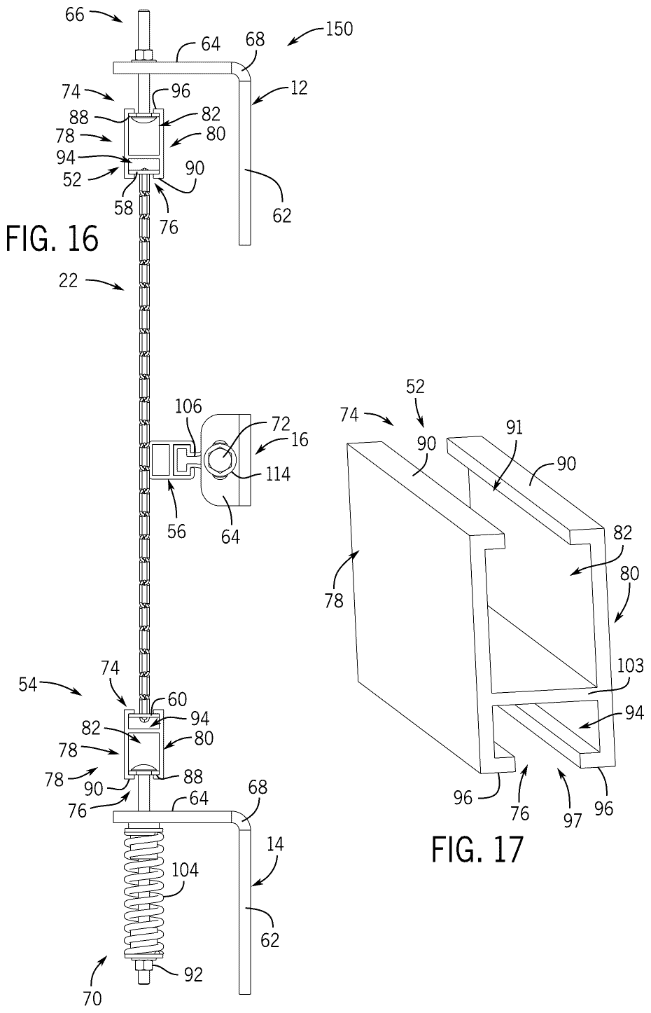

As shown in FIG. 6, the upper rail 52 can include the fastener receiving track 82 and the panel receiving track 94. As discussed above, each track 82, 94 can include three closed sides and a fourth partially open side (e.g., defining open portions 91, 97). Furthermore, in some embodiments, as shown in FIG. 6, the tracks 82, 94 can be identical, such as including identical cross-sectional shapes, areas, lengths, widths, and/or shoulder portions 90, 96. As a result, the upper rail 52 can be used in a first orientation, or flipped and used in a second orientation, without affecting the couplings between the upper rail 52, the upper bracket 12, and the panel 22. Accordingly, reference to the first or upper side 74 of the upper rail 52 may be interchanged with the second or lower side 76 of the upper rail 52. In other forms, the upper rail 52 can define tracks, shoulders, and other features with distinct form factors and/or non-uniform or non-symmetrical cross sections, such as, but not limited to, the examples described below with respect to FIGS. 16-18. Furthermore, any description with reference to the fastener receiving track 82 may equally apply to the panel receiving track 94 and vice versa.

In some embodiments, the tracks 82, 94 can share a common closed side. However, in other embodiments, as shown in FIGS. 3A-6, the upper rail 52 can include a central portion 102 between the fastener receiving track 82 and the panel receiving track 94, separating the tracks 82, 94. For example, the central portion 102 can have a rectangular-or square-shaped cross-section. In some embodiments, the central portion 102 can be hollow and, as a result, can help strengthen the upper rail 52 without adding much additional weight to the upper rail 52. Accordingly, the upper rail 52 can be designed to optimize material usage while providing maximum necessary structural strength. In some embodiments, the size of the central portion 102 can be optimized to meet the needs of a specific panel system. For example, more heavy duty systems can incorporate an upper rail 52 with a larger central portion 102, whereas lighter systems can incorporate an upper rail 52 with a smaller central portion 102 or no central portion 102. Additionally, in some embodiments, a height or a thickness of upper and lower bars 103 defining the central portion 102 (shown in FIG. 6) can be configured for desired structural strength. That is, a thicker bar 103 can provide more structural strength than a thinner bar 103. As the rail 52 can be formed from extruded aluminum rather than, for example, formed sheet metal, the geometry (e.g., thicknesses, heights, etc.) of the rail 52 can be more easily manipulated. For example, forming the rail 52 via aluminum extrusions can allow for adding or subtracting material thickness, changing shapes, etc., which cannot be done as readily with sheet metal parts or other manufacturing techniques.

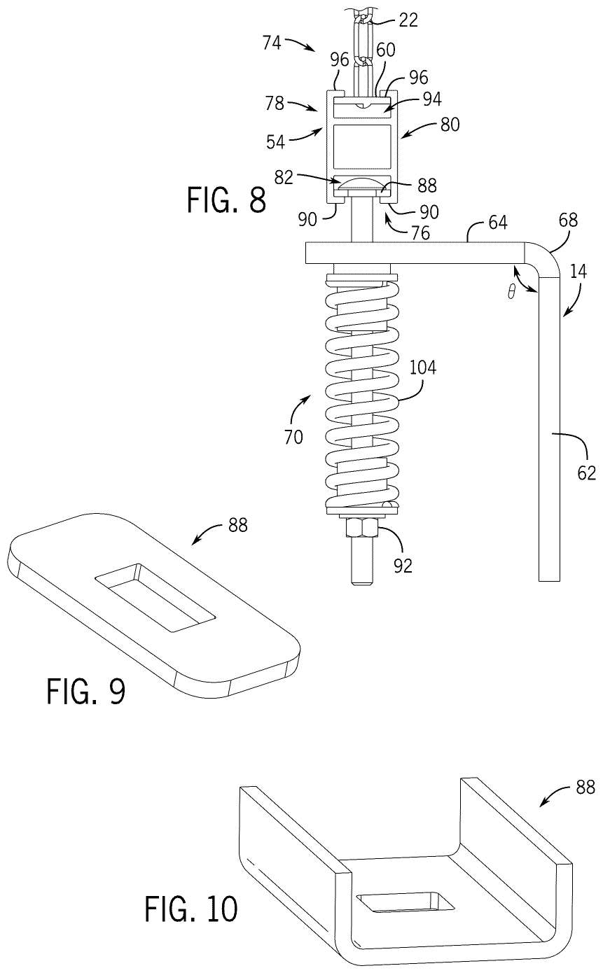

Referring now to FIGS. 3A, 3D, 4, and 8, the lower rail 54 can include a first side 74, a second side 76 opposite the first side 74, a third side 78, and a fourth side 80. The first side 74 may be an upper side, the second side 76 may be a lower side, the third side 78 may be a front side, and the fourth side 80 may be a rear side. In some embodiments, the lower rail 54 can be substantially identical to the upper rail 52. Thus, the above description and related reference numerals with respect to the upper rail 52 can be applied to the lower rail 54. However, certain components may be flipped compared to that described above with respect to the upper rail 52 due to the position of the lower rail 54 relative to the panel 22. For example, as shown in FIG. 8, the first side 74 can include a panel receiving portion, which may be a track 94 that extends from the first end 84 to a second end 86 of the lower rail 54. A panel end plate 60 can be slid into the first end 84 or the second end 86 of the lower rail 54 into the track 94, or inserted anywhere along a length of the track 94, and freely slide laterally through the track 94 (e.g., along the X-axis as shown in FIG. 3A). Furthermore, the track 94 can be completely closed relative to second, third, and fourth sides 76, 78, 80, and partially open on the first side 74 of the lower rail 54. That is, along the first side 74, the track 94 can include shoulder portions 96 that prevent the panel end plate 60 from sliding out of the track 94 in a direction parallel to a length of the panel 22 (e.g., along a Y-axis as shown in FIG. 3A).

The panel end plate 60 can be coupled to the mesh panel 22 via a panel rod 98, as described above. Accordingly, the panel 22 can be sandwiched between two panel end plates (e.g., the upper panel end plate 58 and the lower panel end plate 60). As shown in FIG. 8, when the lower rail 54 is engaged with the panel end plate 60, for example, when the panel end plate 60 is slid along the track 94, the lower rail 54 hangs on the panel end plate 60 as the shoulder portions 96 rest along a top side of the panel end plate 60. Thus, the panel end plate 60 fastens the panel 22 to the lower rail 54. Furthermore, as discussed above, because the panel end plate 60, rather than the panel 22 itself, is coupled to the lower rail 54, a common lower rail 54 can be used for any type of panel (e.g., mesh panel 22). Additionally, because the upper rail 52 and the lower rail 54 can be identical, a common, single rail can be used. Accordingly, the rail of FIG. 6 may be an upper rail 52, as referenced above, or a lower rail 54. Such standardization can allow for fewer components to be in inventory at one time.

Referring back to FIG. 8, the second side 76 of the lower rail 54 can include a fastener receiving portion, which may be a track 82 that extends from the first end 84 to the second end 86 of the lower rail 54. One or more washers 88 can be slid from the first end 84 or the second end 86 of the lower rail 54 into the track 82, or inserted anywhere along a length of the track 82, and freely slide laterally through the track 82 (e.g., along a direction parallel to a width of the panel 22, or along the X-axis shown in FIG. 3A). Furthermore, the track 82 can be completely closed relative to first, third, and fourth sides 74, 78, 80, and partially open on the second side 76 of the lower rail 54. That is, along the second side 76, the track 82 can include shoulder portions 90 that prevent the washer 88 from sliding out of the track 82 in a direction parallel to a length of the panel 22 (e.g., along a Y-axis as shown in FIG. 3A).

For example, as shown in FIG. 8, a mounting fastener 70, such as a spring-loaded carriage bolt, can extend through the washer 88 and extend through a mounting bracket hole 32 in the lower bracket 14 and be secured to the lower bracket 14. When the lower rail 54 is engaged with the washer 88, for example, when the washer 88 is inserted along the track 82, the washer 88 hangs on the lower rail 54 as the washer 88 rests along top sides of the shoulder portions 90. Thus, the washer 88 and bolt 70 combination fastens the lower rail 54 to the lower bracket 14. As a result, in some embodiments, the washer 88 and carriage bolt 70 combination can be collectively referred to as a mounting fastener for the lower rail 54. Furthermore, as shown in FIGS. 3A, 3D, 4, and 8, the spring-loaded bolt 70 can include a spring 104 that urges the bolt 70 away from the panel 22 and, as a result, pulls the panel 22 toward the lower bracket 14 and away from the upper bracket 12, thus holding the panel 22 in tension. In other embodiments, the biasing element (e.g., spring 104) may take or include other forms, such as resilient/compressible rubber or plastic sleeves, or beam, leaf, and disk springs.

Additionally, as discussed above, because the washers 88 can slide anywhere along a length of the track 82 between the first end 84 and the second end 86 of the lower rail 54, there is no singular, preset mounting alignment between the lower bracket 14 and the lower rail 54, allowing for flexibility when mounting the lower bracket 14 to the lower rail 54 in the field. The present mounting design also allows for any number of bolts 70 to be used. For example, while two bolts 70 are shown in FIGS. 3A and 4, a single bolt 70 or more than two bolts 70 may be used in some applications. While additional mounting bracket holes 32 would need to be drilled/formed/laser cut in the lower bracket 14 to accommodate more bolts 70, no further accommodations need to be made to the lower rail 54, as additional washers 88 need only be inserted into the track 82. Furthermore, as shown in FIG. 3A, because the washers 88 are slid along a length of the track 82 between the first end 84 and the second end 86 of the lower rail 54 to secure the lower rail 54 to the lower bracket 14, no fasteners are visible along the third side 78 of the lower rail 54.

It should also be noted that, while carriage bolts 70 and washers 88 are shown and described herein, other types of mounting fasteners may be used in some embodiments with the upper rail 52 and/or the lower rail 54. Such mounting fasteners can include a fastening portion that is coupled to the bracket 12/14 and an extension that interlocks with and can slide through the track 82 of the rail 52/54. The fastening portion and the extension may be separate components, such as a carriage bolt 66/70 and a washer 88, respectively, or may be a single integral component. For example, in some embodiments, a mounting fastener may be a T-bolt, a welded stud, a bolt-and-washer combination, a machined, cast, or molded member, or other components that can be slid through a track and coupled to a bracket.

Furthermore, as discussed above with respect to the upper rail 52, the lower rail 54 can include the fastener receiving track 82 and the panel receiving track 94. In some embodiments, the tracks 82, 94 can be identical, such as including identical cross-sectional shapes, areas, lengths, widths, and/or shoulder portions 90, 96. As a result, the lower rail 54 can be used in a first orientation, or flipped and used in a second orientation, without affecting the couplings between the lower rail 54, the lower bracket 14, and the panel 22. In some embodiments, the tracks 82, 94 can share a common closed side or, in other embodiments, the lower rail 54 can include a central portion 102 between the fastener receiving track 82 and the panel receiving track 94, as discussed above with respect to the central portion 102 of the upper rail 52. In other forms, the lower rail 54 can define tracks, shoulders, and other features with distinct form factors and/or non-uniform or non-symmetrical cross sections.

Referring now to FIGS. 3A, 3C, 4, 11, 12, and 13, in some embodiments, the middle rail 56 can include a fastener receiving portion and a panel receiving portion. More specifically, the middle rail 56 can include a first side 74, a second side 76 opposite the first side 74, a third side 78, and a fourth side 80. The first side 74 may be an upper side, the second side 76 may be a lower side, the third side 78 may be a front side, and the fourth side 80 may be a rear side. The fourth side 80 can include a fastener receiving portion, which may be a track 82 that extends from a first end 84 to a second end 86 of the middle rail 56. One or more links 106 can be slid from the first end 84 or the second end 86 of the middle rail 56 into the track 82, or otherwise inserted into the track 82, and freely slide laterally through the track 82 (e.g., along a direction parallel to a width of the panel 22, or along an X-axis shown in FIG. 3A).

For example, as shown in FIG. 13, each link 106 can include a first portion 108 including a cross-sectional shape that substantially matches a cross-sectional shape of the track 82, allowing the first portion 108 to be slid along the track 82, and a second portion 110 including an opening. Furthermore, the track 82 can be completely closed relative to first, second, and third sides 74, 76, 78, and partially open on the fourth side 80 of the middle rail 56. That is, along the fourth side 80, the track 82 can include shoulder portions 90 that prevent the link 106 from sliding out of the track 82 in a direction perpendicular to a length of the panel 22 (e.g., along a Z-axis as shown in FIG. 3A).

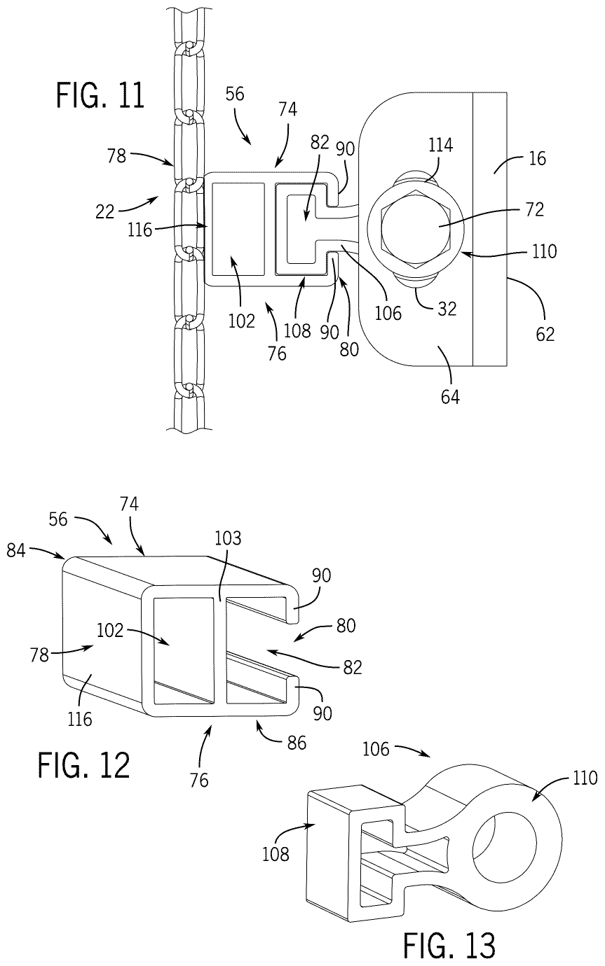

As shown in FIGS. 3A, 3C, 4, and 11, a bolt 72 can extend through the second portion 110 of the link 106, extend through mounting bracket holes 32 in the middle bracket 16, and be secured to the middle bracket 16 via fasteners 114, such as a nut and washers. When the middle rail 56 is engaged with the link 106, for example, when the link 106 is slid along the track 82, the shoulder portions 90 prevent the link 106 from sliding out of the track 82. Thus, the link 106 and bolt 72 combination fastens the middle rail 56 to the lower bracket 14. As a result, in some embodiments, the link 106 and bolt 72 combination can be collectively referred to as a mounting fastener for the middle rail 56. Furthermore, because the links 106 can slide anywhere along a length of the track 82 between the first end 84 and the second end 86 of the middle rail 56, there is no singular, preset mounting alignment between the middle bracket 16 and the middle rail 56, allowing for horizontal flexibility when mounting the middle bracket 16 to the middle rail 56 in the field. Additionally, as shown in FIG. 11, the mounting bracket holes 32 in the middle brackets 16 can be oval in shape, thus also providing some vertical flexibility when securing the middle bracket 16 to the middle rail 56, as the bolt 72 can be positioned anywhere along a height of the mounting bracket holes 32.

The present mounting design also allows for any number of links 106 and middle brackets 16 to be used. For example, while two middle brackets 16 are shown in FIG. 1, a single middle bracket 16 or more than two middle brackets 16 may be used in some applications. No further accommodations need to be made to the middle rail 56, as additional links 106 need only be inserted into the track 82. Additionally, in some embodiments, the links 106 may also be formed from extruded aluminum. Thus, the middle rail 56 can include an assembly of interlacing extrusions (i.e., the extruded rail 56 and the extruded link 106).

Referring still to FIGS. 3A, 3C, 4, 11, and 12, the third side 78 of the middle rail 56 can include a panel receiving portion 116, which may be a substantially flat face of the third side 78. As a result, the panel 22 can be secured to the panel receiving portion 116 with fasteners (not shown) that extend through the panel 22 and into the panel receiving portion 116 to help minimize panel movement along the Z-axis, for example, due to wind loads. The fasteners can also minimize panel movement along the X-axis, for example, due to the panel 22 independently sliding relative to the upper bracket 12 and the lower bracket 14 (though, generally, panel movement along the X-axis can be restricted simply via friction due to the panel 22 being under tension). However, the middle rail 56 can still allow for panel movement along the Y-axis, as the link 106 can, in some forms, freely rotate about the bolt 72 and/or the bolt 72 may translate within the slotted mounting bracket holes 32. Additionally, in some embodiments, the panel receiving portion 116 can include mounting holes (not shown) to receive the fasteners. For example, in one embodiment, the fasteners can be self-tapping screws and the panel receiving portion 116 can include pre-drilled mounting holes (e.g., pilot holes) to receive the self-tapping screws.

As shown in FIGS. 3A, 3C, 4, 11, and 12, the middle rail 56 can include the fastener receiving track 82 and the panel receiving portion 116. As discussed above, the fastener receiving track 82 can include three closed sides and a fourth partially open side. In some embodiments, the fastener receiving track 82 can share a common closed side with the panel receiving portion 116. However, in other embodiments, as shown in FIG. 3A, 3C, 4, 11, and 12, the middle rail 56 can include a central portion 102 between the fastener receiving track 82 and the panel receiving portion 116. For example, the central portion 102 can have a square-or rectangular-shaped cross-section. The central portion 102 can be substantially hollow, thus providing an open cavity to receive a fastener inserted through the panel receiving portion 116, as described above. Furthermore, in some embodiments, the hollow central portion 102 can help strengthen the middle rail 56 without adding much additional weight to the middle rail 56. Accordingly, the middle rail 56 can be designed to optimize material usage while providing maximum necessary structural strength. In some embodiments, the size of the central portion 102 can be optimized to meet the needs of a specific panel system. For example, more heavy duty systems can incorporate a middle rail 56 with a larger central portion 102, whereas lighter systems can incorporate a middle rail 56 with a smaller central portion 102 or no central portion 102. Further, in other embodiments, a thickness or height of the bars defining the central portion 102, rather than the size of the central portion 102, can be optimized to meet the needs of the panel system (e.g., where heavier duty systems incorporate thicker bars while lighter duty systems incorporate thinner bars).

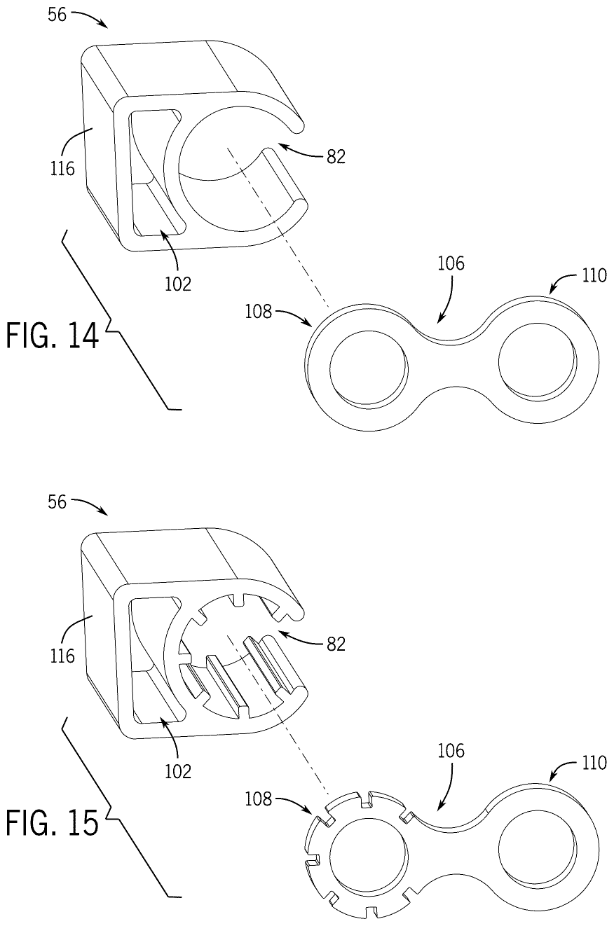

FIGS. 14 and 15 illustrate additional example middle rails 56 and links 106 according to some embodiments. Like the link 106 of FIG. 13, the links 106 of FIGS. 14 and 15 each include a first portion 108 including a cross-sectional shape that substantially matches a cross-sectional shape of the track 82 of the middle rail 56, allowing the first portion 108 to be slid along the track 82, and a second portion 110 including an opening. With respect to the link 106 of FIG. 14, the cross-sectional shape of the first portion 108 can be substantially circular, while the track 82 of the middle rail 56 can include a matching cross-section. With respect to the link 106 of FIG. 15, the cross-sectional shape of the first portion 108 can be substantially circular with indents, while the track 82 of the middle rail 56 can include a matching cross-section with protrusions that fit into (e.g., keyed to) the indents.

Referring now to FIGS. 16, 17, and 18, an architectural panel tension mounting system 150 according to some embodiments is illustrated. The system 150 of FIGS. 16-18 can be substantially similar to the system 50 of FIGS. 3A-13, including a set of brackets and a coupling system including a set of rails, mounting fasteners, and panel end plates. Thus, unless specified otherwise, any of the above description and reference numerals related to the system 50 can be equally applicable to the system 150.

Accordingly, as shown in FIG. 16, the set of brackets can include an upper bracket 12, a lower bracket 14, and one or more middle brackets 16. Furthermore, the set of rails can include an upper rail 52, a lower rail 54, and a middle rail 56 corresponding to the upper bracket 12, the lower bracket 14, and the middle brackets 16, respectively, and the panel end plates can include an upper panel end plate 58 and a lower panel end plate 60 corresponding to the upper rail 52 and the lower rail 54, respectively. It should be noted that, though numbered differently, in some embodiments, the upper and lower rails 52, 54, the upper and lower brackets 12, 14, and/or the panel end plates 58, 60 may be identical.

FIG. 17 illustrates an upper rail 52 of the system 150. As shown in FIG. 17, the upper rail 52 can be substantially similar to the upper rail 52 illustrated in FIG. 6, but not include a central portion 102. More specifically, while the upper rail 52 of FIG. 6 includes two bars 103 defining the central portion 102, the upper rail 52 of FIGS. 16-18 includes a single bar 103. Additionally, while the upper rail 52 of FIG. 6 includes a fastener receiving track 82 and a panel receiving track 94 equal in size and height, the upper rail 52 of FIGS. 16-18 include tracks 82, 94 that are different heights. That is, as best shown in FIG. 17, a height of the fastener receiving track 82 can be substantially larger than a height of the panel receiving track 94.

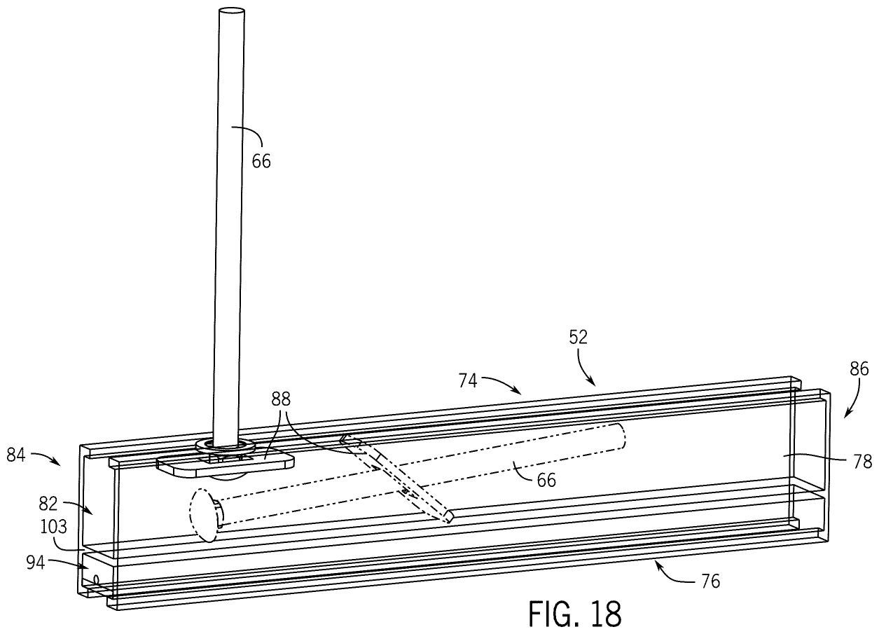

As a result, in some embodiments, as shown in FIG. 18, the fastener receiving track 82 can be tall enough to accommodate a mounting fastener 66 (shown for clarity) to be slid through the track 82 beneath the shoulder portions 90, i.e., substantially entirely between the first side and the second side. In this manner, a second mounting fastener 66 can be slid through the track 82 while a first mounting fastener 66 is already installed. This can allow for adjustments or replacement of certain mounting fasteners 66 without having to uninstall and reinstall the entire coupling system.

Additionally, referring back to FIG. 16, in some embodiments, the lower rail 54 can be substantially identical to the upper rail 52. Thus, the above description and related reference numerals with respect to the upper rail 52 can be applied to the lower rail 54, though, certain components may be flipped compared to that described above with respect to the upper rail 52 due to the position of the lower rail 54 relative to the panel 22. Accordingly, though the tracks 82, 94 are not identical in shape, the same rail can be used as a lower rail 54 a first orientation, or flipped and used as an upper rail 52 in a second orientation.

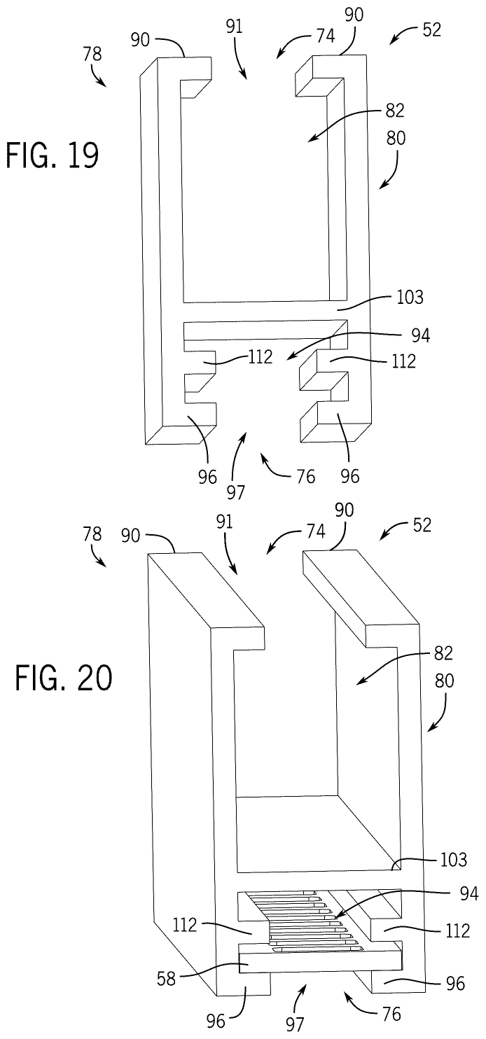

Furthermore, referring to FIGS. 19 and 20, another example upper rail 52, according to some embodiments, is illustrated for use with the systems 50, 150 described herein. As shown in FIG. 19, the upper rail 52 can be substantially similar to the upper rail 52 illustrated in FIGS. 16-18, including a single central bar 103, though the upper rail 52 may alternatively include two bars 103 defining a central portion, similar to the upper rail 52 of FIG. 6. Additionally, upper rail of FIG. 19 includes a lip 112 extending inward from the third side 78 and the fourth side 80 into the panel receiving track 94.

As a result, in some embodiments, as shown in FIG. 20, the lips 112 act as secondary shoulder portions within the panel receiving track 94. When an upper panel end plate 58 is inserted into the panel receiving track 94, the upper panel end plate 58 can be received between the shoulder portions 96 and the lips 112. The lips 112, therefore, can substantially prevent the upper panel end plate 58 from, for example, floating upward within the panel receiving track 94 and contacting the central bar 103. Minimizing vertical movement of the mesh panel 22, by sandwiching the upper panel end plate 58 between the shoulder portions 96 and the lips 112 within the panel receiving track 94, can make panel installation easier. Accordingly, a length of each lip 112 can be long enough to maintain the upper panel end plate 58 between the shoulder portions 96 and the lips 112. For example, while the lips 112 are shown as including a length that extends into the panel receiving track 94 equal to a length of the shoulder portions 96, the lips 112 can include lengths shorter or longer than the length of the shoulder portions 96. In one embodiment, the lips 112 can extend far enough into the panel receiving track 94 such that they meet, creating a single bar (not shown) extending across the panel receiving portion 94.

Additionally, in some embodiments, a system 50, 150 can include a lower rail 54 that can be substantially identical to the upper rail 52 shown in FIGS. 19 and 20. Thus, the above description and related reference numerals with respect to the upper rail 52 can be applied to a lower rail 54, though, certain components may be flipped compared to that described above with respect to the upper rail 52 due to the position of the lower rail 54 relative to the panel 22. Accordingly, though the tracks 82, 94 are not identical in shape, the same rail can be used as a lower rail 54 a first orientation, or flipped and used as an upper rail 52 in a second orientation.

While the example panel 22 for use with the systems 50, 150 described herein is described as a mesh panel 22, the panel may take a variety of forms. For example, the panel can be a mesh panel of a tighter weave, a non-homogenous weave that incorporates wires of multiple diameters, and any other variation of available mesh. In addition, the panel can be designed to include a non-metallic (e.g., plastic) panel (with or without openings of uniform or non-uniform dimension and array orientation), incorporate fixed or dynamic louvers, and any other combination of conventional panels.

As discussed above, the rails 52-56 can be formed from extruded aluminum. The rails 52-56, therefore, can be lighter and more economical than stainless steel options but still provide sufficient strength for mounting panels (e.g., mesh panels 22). It should be noted, however, that extruded materials other than aluminum may be used in some embodiments. In addition, the various components and structure need not be formed from an extrusion process, but can be otherwise formed, such as molded, machined, cast, printed, and similar manufacturing processes that allow for forming the desired structures. Furthermore, unlike stainless steel bindings, which must be laser-cut to length and, thus, limited in length by the size of associated manufacturing equipment, the elongated rails (e.g., extrusions) can be easily made in longer lengths to accommodate fewer components for mounting panels. As a result, longer rails (e.g., extrusions) can allow for wider panels to be used. For example, in some embodiments, the extrusions can be made up to about 20 feet in length. Furthermore, as discussed above, the extrusions can be used with many different panel specifications (e.g., due to engaging panel end plates 58, 60 rather than the mesh itself) instead of being formed to match only one or a small number of panel specifications. As a result, the tension mounting systems 50, 150 of some embodiments can be more standardized. That is, rather than having bindings that are made-to-order (e.g., by being laser cut, sanded, formed, and passivated), common extrusions maintained in-stock need only be cut to length, which can reduce overall manufacturing costs and manufacturing lead times. Additionally, due to the above-described track design, mounting fasteners 66, 70 can be positioned anywhere along a width of a panel to mount the panel to brackets 12, 14, creating adjustability to overcome unforeseen field conditions during panel installation. As a result, field conditions that would otherwise require manufacturing of new parts can instead be accommodated with simple adjustments along tracks.

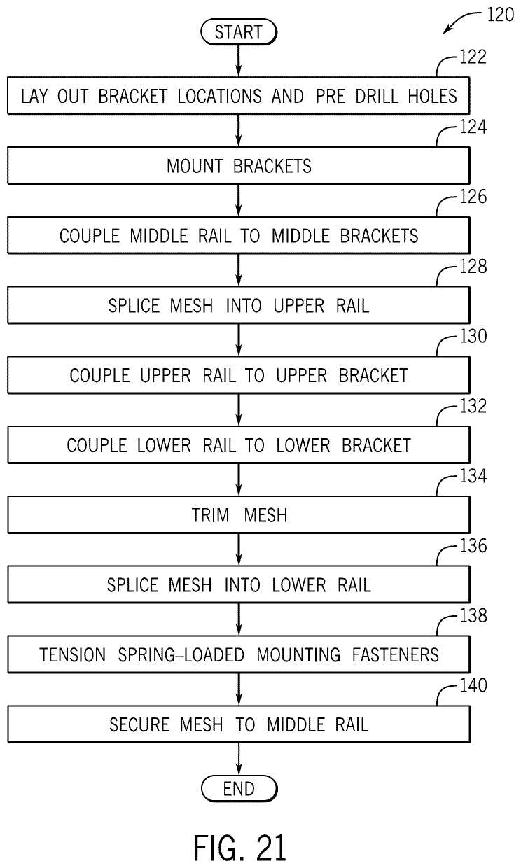

For example, FIG. 21 illustrates a method 120 of installing a panel (e.g., a mesh panel 22) according to some embodiments. As shown in FIG. 21, the method 120 can generally include laying out bracket locations of the upper, middle, and lower brackets 12-16 relative to a structural support and pre-drilling mounting bracket holes 32 through the brackets 12-16 (step 122), mounting the brackets 12-16 to the structural support (step 124), coupling the middle rail 56 to the middle bracket 16 (step 126), splicing the mesh panel 22 into the upper rail 52 (step 128), coupling the upper rail 52 to the upper bracket 12 (step 130), coupling the lower rail 54 to the lower bracket 14 (step 132), trimming the mesh panel 22 (step 134), splicing the mesh panel 22 into the lower rail 54 (step 136), tensioning the spring-loaded mounting fasteners 70 (step 138), and securing the mesh panel 22 to the middle rail 56 (step 140).

More specifically, step 122 can include laying out bracket locations of the upper, middle, and lower brackets 12-16 relative to a structural support and pre-drilling mounting bracket holes 32 through the brackets 12-16. For example, in some applications, bracket locations may be preplanned, though slight adjustments may need to be made in the field to avoid impediments, such as wall seams or protrusions. Furthermore, mounting bracket holes 32 can be drilled through the brackets 12-16, and the brackets 12-16 can be mounted at step 124 using conventional fasteners (e.g., concrete anchors).

At step 126, the middle rail 56 can be coupled to the middle brackets 16. For example, the links 106 can be coupled to the middle brackets 16 by inserting bolts 72 through the second portions 110 of the links 106 and the mounting bracket holes 32 of the middle brackets 16, and securing the bolts 72 to the middle brackets 16. Furthermore, the middle rail 56 can be interlocked with the links 106 by sliding the middle rail 56 relative to the links 106 so that the first portion 108 of each link 106 slides through the track 82 of the middle rail 56. Alternatively, in some embodiments, the middle rail 56 can be coupled to the links 106 by snapping the middle rail 56 over the first portions 108, e.g., in the Y- and or Z-directions, rather than sliding in the X-direction.

At step 128, the mesh panel 22 can be spliced into the upper rail 52. That is, the mesh can be coupled to a panel end plate 58 via a panel rod 98, as described above. Then, the panel end plate 58 can be slid or otherwise inserted into the track 94 of the upper rail 52. Alternatively, in some embodiments, the panel end plate 58 can be first inserted into the track 94 of the upper rail 52. Then, the mesh can be coupled to the panel end plate 58 via the panel rod 98. At step 130, the upper rail 52 can be coupled to the upper bracket 12 using the mounting fasteners 66. That is, the mounting fasteners 66, such as the carriage bolts and washers 88, can be slid or otherwise inserted into the track 94 of the upper rail 52; the assembly (i.e., the mesh panel 22, the upper rail 52, and the mounting fasteners 66) can be lifted toward the upper bracket 12 and the mounting fasteners 66 can be coupled to the upper bracket 12.

At step 132, the lower rail 54 can be coupled to the lower bracket 14. For example, the mounting fasteners 70 can be slid or otherwise inserted into the track 82 of the lower rail 54 and loosely coupled to the lower bracket 14. At step 134, the mesh panel 22 can be trimmed to a desired length. For example, in some applications, the mesh panel 22 can be initially rolled up during steps 128 and 130. At step 134, the mesh panel 22 can be unrolled and trimmed to a length that permits the mesh to extend from the upper rail 52 to the lower rail 54 in tension. After the mesh is trimmed, it can be spliced into the lower rail 54 at step 136. At step 136, like step 128 described above, the mesh can be coupled to a panel end plate 60 via a panel rod 98. Then, the panel end plate 60 can be slid or otherwise inserted into the track 94 of the lower rail 54. Alternatively, in some embodiments, the panel end plate 60 can be first inserted into the track 94 of the lower rail 54. Then, the mesh can be coupled to the panel end plate 60 via the panel rod 98.

Once the mesh panel 22 is coupled to the lower rail 54, the spring-loaded mounting fasteners 70 that couple the lower rail 54 to the lower bracket 14 can be tightened to place the panel 22 in tension at step 138. At step 140, the mesh panel 22 can be secured to the middle rail 56. For example, self-tapping screws can be used to couple the mesh panel 22 to the panel receiving portion 116 of the middle rail 56.

The above method 120 can be repeated for multiple mesh panels 22. In some embodiments, the above method 120 can be executed in an iterative manner or partially iterative manner, such that one or more method steps are repeated for successive panel systems before proceeding to a further method step. For example, in some applications, steps 122-126 can be initially performed for all panels 22 so that all brackets 12-16 and middle rails 56 are installed before any panels 22 are installed. In other embodiments, the above method 120 can be executed as a singular process, such that all method steps 122-140 are completed to install a first panel 22 before proceeding with steps 122-140 for a second, subsequent panel 22. Additionally, while the steps of the method 120 are shown and described above in a particular order, in some embodiments, the method 120 may not include all steps shown, may include additional steps, or may include the steps in a different order. For example, in some applications, the system 50 does not require middle brackets 16 and middle rails 56. As such, in those applications, steps 126 and 140 may be eliminated.

It is to be understood that the disclosure is not limited in its application to the details of construction and the arrangement of components set forth in the accompanying description or illustrated in the accompanying drawings. Given the benefit of this disclosure, one skilled in the art will appreciate that the disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” “back,” “leading,” or “trailing” features is generally intended as a description only of the orientation of such features relative to a reference frame of a particular example or illustration. Correspondingly, for example, a “top” or “upper” feature may sometimes be disposed below a “bottom” or “lower” feature (and so on), in some arrangements or embodiments. Further, references to particular rotational or other movements (e.g., counterclockwise rotation) is generally intended as a description only of movement relative a reference frame of a particular example of illustration. Additionally, as used herein, unless otherwise defined or limited, directional terms are used for convenience of reference for discussion of particular figures or examples. For example, references to top, bottom, upward, downward, trailing, leading, or other directions, orientations, or positions may be used to discuss aspects of a particular example or figure, but do not necessarily require similar orientation or geometry in all installations or configurations.

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, the term “about” or “approximately” or “substantially” refers to variation in the numerical quantity that may occur, for example, through typical measuring and manufacturing procedures used for conveyor belts or other articles of manufacture that may include embodiments of the disclosure herein; through inadvertent error in these procedures; through differences in the manufacture, source, or purity of the ingredients used to make the compositions or mixtures or carry out the methods; and the like. Throughout the disclosure, the terms “about,” “approximately,” and “substantially” refer to a range of values +20% of the numeric value that the term precedes.

This discussion is presented to enable a person skilled in the art to make and use embodiments of the disclosure. Given the benefit of this disclosure, various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The accompanying detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. An architectural panel mounting system configured to be coupled to a structural support via a first bracket, a second bracket, and a third bracket, the architectural panel mounting system comprising:
a first rail comprising a first panel receiving track and a first fastener receiving track;
a first set of mounting fasteners configured to be received into the first fastener receiving track and configured to be coupled to the first bracket, wherein the first set of mounting fasteners are slidable within the first fastener receiving track;
a second rail comprising a second panel receiving track and a second fastener receiving track;
a second set of mounting fasteners configured to be received into the second fastener receiving track and configured to be coupled to the second bracket, wherein the second set of mounting fasteners are slidable within the second fastener receiving track;
a third rail comprising a third fastener receiving track;
a third set of mounting fasteners configured to be received into the third fastener receiving track and configured to be coupled to the third bracket; and
a mesh panel configured to be received into the first panel receiving track and the second panel receiving track, wherein the mesh panel is slidable relative to the first panel receiving track and the second panel receiving track.

2. The architectural panel mounting system of claim 1, wherein the first rail, the second rail, and the third rail are extruded rails.

3. The architectural panel mounting system of claim 1, wherein the first rail, the second rail, and the third rail are aluminum extrusions.

4. The architectural panel mounting system of claim 1, wherein the first set of mounting fasteners include carriage bolts.

5. The architectural panel mounting system of claim 1, wherein the second set of mounting fasteners include spring-loaded carriage bolts.

6. The architectural panel mounting system of claim 1, wherein the third set of mounting fasteners include links configured to be received into the third rail.

7. The architectural panel mounting system of claim 6, wherein the links are configured to be rotatable relative to the third bracket when coupled to the third bracket.

8. The architectural panel mounting system of claim 1, wherein the first rail comprises a central portion separating the first panel receiving track and the first fastener receiving track.

9. The architectural panel mounting system of claim 1, wherein the first panel receiving track and the first fastener receiving track each extend from a first end of the first rail to a second end of the second rail.

10. The architectural panel mounting system of claim 1, wherein the mesh panel is coupled to a first panel end plate along a first end thereof, and the first panel end plate is configured to be received into the first panel receiving track.

11. An architectural panel mounting system comprising:
a panel;
a first rail coupled to the panel;
a second rail coupled to the panel a first bracket, the first rail being coupled to the first bracket and configured to be slidable laterally relative to the first bracket; and
a second bracket, the second rail being coupled to the second bracket and configured to be slidable laterally relative to the second bracket.

12. The architectural panel mounting system of claim 11, wherein the second rail is coupled to the second bracket using spring-loaded mounting fasteners to hold the panel in tension.

13. The architectural panel mounting system of claim 11, further comprising a third rail coupled to the panel; and a third bracket, the third rail being coupled to the third bracket and configured to be slidable laterally relative to the third bracket.

14. The architectural panel mounting system of claim 11, wherein the panel is configured to be slidable into a first track of the first rail to couple the first rail to the panel.

15. The architectural panel mounting system of claim 14, wherein the panel is coupled to a first panel end plate, and the first panel end plate is configured to be slidable into the first track.

16. The architectural panel mounting system of claim 11, wherein the first rail is coupled to the first bracket via mounting fasteners, wherein the mounting fasteners extend through mounting bracket holes of the first bracket.

17. A method of installing an architectural panel to a structural support, the method comprising:
mounting an upper bracket and a lower bracket to the structural support;
inserting an architectural panel into a track of an upper rail;
coupling the upper rail to the upper bracket by inserting upper rail mounting fasteners into a track of the upper rail and fastening the upper rail mounting fasteners to the upper bracket, wherein the upper rail mounting fasteners are slidable relative to the track of the upper rail;
coupling a lower rail to the lower bracket by inserting lower rail mounting fasteners into a track of the lower rail and fastening the lower rail mounting fasteners to the lower bracket, wherein the lower rail mounting fasteners are slidable relative to the track of the lower rail; and
inserting the architectural panel into a track of the lower rail.

18. The method of claim 17, further comprising:
mounting a middle bracket to the structural support between the upper bracket and the lower bracket;
coupling a middle rail to the middle bracket via links that slide into a track of the middle rail; and
coupling the architectural panel to the middle rail.

19. The method of claim 17, wherein the architectural panel is slidable relative to the track of the upper rail and the track of the lower rail.

20. The method of claim 17, wherein inserting the architectural panel into the track of the upper rail includes coupling the architectural panel to a panel end plate and inserting the panel end plate into the track of the upper rail.
